(19) United States
(12) Patent Application Publication
(10) Pub. No.: US 2007/0020371 A1
(43) Pub. Date: Jan. 25, 2007

(54) Production of milk protein ingredient with high whey protein content

(76) Inventors: Samuel Dylan Quinn Cuksey, Palmerston North (NZ); Peter Dudley Elston, Palmerston North (NZ); Ganugapaii Vijaya Bhaskar, Palmerston North (NZ); Brent Anthony Vautier, Palmerston North (NZ); Siew Kim Lee, Palmerston North (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/545,522

(22) PCT Filed: Aug. 9, 2004
(86) PCT No.: PCT/NZ04/00179

§ 371 Date: Sep. 25, 2006

(30) Foreign Application Priority Data
Aug. 7, 2003 (NZ) NZ 527436

(51) Int. Cl. A23C 21/00

(52) U.S. Cl. 426/583

(57) ABSTRACT

The invention described is a milk protein composition having a high percentage of the whey protein from the dairy stream from which is was derived bound to the casein from that stream. The composition is prepared by a process in which the dairy stream heated during a holding period. A transglutaminase enzyme is added and the stream is again heated. This is followed by a step of coagulating the curd in the protein composition by the addition of a milk clotting enzyme or by acidifying. The milk protein composition may then be dried into a powder for use in cheese making.

### BACKGROUND TO THE INVENTION

1. Filed of the Invention

The invention relates to the preparation of a novel dairy ingredient. Specifically the invention relates to the production of a dairy ingredient displaying an improved level of retention of whey protein and improved rheological properties.

2. Description of the Related Art

Cheese and cheese compositions are usually produced by treating a dairy stream with a coagulant, or clotting agent (such as rennet) to produce a coagulum and serum. The coagulum is referred to as “curd” and the serum is referred to as “whey”. The coagulum generally includes casein, fats and can undergo a micro-organism treatment to produce flavours. Further processing results in cheese and similar cheese compositions.

The whey generally contains soluble proteins little affected by the coagulant or clotting agent, and hence the coagulum does not tend to contain all the protein of the initial dairy stream. The art disclose a wide variety of methods to improve cheese yield by incorporating whey proteins.

U.S. Pat. No. 4,376,072 teaches a process for linking soluble proteins to casein by an alkaline treatment combined with heating. A protein ingredient is then prepared by precipitating the treated protein by the addition of acid to pH about 4 and drying or resolublising in alkali to pH about 7 and drying. Limited aggregation of the soluble proteins to the casein is possible in this process.

Also important are the interactions between casein proteins and whey proteins, because if suitably controlled, these can result in useful textural attributes. Such attributes include solution viscosity, gelation, texture and heat stability.

Analogous to the action of rennet on casein, enzymes, particularly protein active enzymes, can be used to control the interaction between casein and other proteins, particularly whey proteins.

Patent application US2003/0165594 discloses a variety of methods of modifying the characteristics of cheese and processed cheese using the enzyme transglutaminase (TG). Cheese particles or cheese curd may be treated by contacting with a solution of the enzyme. The treated material may then be converted to processed cheese. Alternatively, ultrafiltration retentate may be treated with the transglutaminase enzyme and the solution concentrated and converted into processed cheese. These processes have various limitations and inefficiencies relating to linking significant amounts of the soluble proteins originally present in the milk to the casein or inefficient concentration of the retentate.

U.S. Pat. No. 6,270,814 teaches another process using the enzyme transglutaminase. This process treats a dairy solution containing casein, whey protein and lactose with transglutaminase. Fat, acid and salts are added and the mixture is homogenised and then mixed with molten cheese in the processed cheese cooker. After cooking the melt is poured off and packed as processed cheese. The claimed advantages of this process include reduced propensity of the lactose to crystallise in the product, altering the water binding properties of the proteins and improvement to the melting behaviour of the product. This process does not enable the yield enhancing attributes of transglutaminase to be exploited because no whey or serum is lost or expelled from the process. The invention does not teach that the texture of the processed cheese can be modified by treatment of the ingredient preparation step with transglutaminase.

U.S. Pat. No. 6,572,901 teaches a further variation on the use of transglutaminase to produce a cheese product. A dairy liquid is treated with acid and transglutaminase. The acid may be produced using a lactic starter culture to develop lactic acid during the enzyme reaction stage. The pH of the reacted dairy liquid is preferably about pH 4.5 to 4.7. The resulting curd is cooked and if desired curds and whey are separated. No rennet is used in the process. Other cheese making ingredients may be added if required to produce the final cheese. A homogenisation step may be used. Preferred products are cream cheese and cottage cheese. Enhanced protein yield and textural benefits are claimed in the process. No dry ingredient preparation step is used so that the ability to carry out the process to prepare the enzyme modified protein in a different time and place from the production of the cheese product is not able to be realised. The initial dairy liquid is not heat treated beyond normal pasteurisation.

U.S. Pat. No. 6,224,914 discloses a process where a whey protein containing liquid (but not including casein) maybe subjected to a heat treatment (to unfold the proteins) and treated with the enzyme transglutaminase. The reacted liquid is then mixed with a dairy stream containing casein but preferably not fortified with whey protein. The casein containing stream may be cultured before mixing with the whey protein reacted stream. Rennet is added to the mixed streams, set, and treated according to conventional cheese making practice to yield curds and whey which may then be converted to cheese. By treating the whey protein with transglutaminase without the presence of casein, the ability to crosslink or form molecular structures between casein and whey protein molecules appears limited.

U.S. Pat. No. 6,093,424 and U.S. Pat. No. 6,242,036 disclose yet another variation on the use of the enzyme transglutaminase in the manufacture of cheese. A dairy fluid containing casein and whey protein is heat treated and then treated with transglutaminase. After treatment, a non-rennet protease enzyme is added which results in the formation and separation of the curds and whey. The curds are treated using cheese making methods known in the art into cheese. Cheese yield is claimed to be significantly increased. Curds are formed without acidification to a pH<5.5.

JP-A 3160957 discloses a procedure where milk, reconstituted milk or a caseinate solution is treated with the enzyme (TG) in the pH range 5-9 and spray dried to produce a modified milk protein ingredient. The drying process would have been inefficient due to the high viscosity or propensity of the treated solution to gel. There is no step disclosed of acidification of the enzyme treated solution to produce a protein concentrate and separation of serum.

WO 0170041A1 & WO 0170042A1, each teach of a method to produce an enzyme treated caseinate ingredient by the use of the enzyme TG and roller drying the treated solution for use in processed cheese manufacture. Schmelter, van Dijk & Clark point out that high viscosity (or gelation characteristics) of protein solutions treated with such enzymes makes spray drying impractical because of the very low solids able to be used in the drier feed stream (5-20% solids). Schmelter, van Dijk & Clark teach that roller drying overcomes such difficulty where the solids concentration of the enzyme treated feedstock is in the range 5-30%.

WO 9319610 discloses a process where a milk protein containing solution is treated with the TG enzyme. It is claimed that when the treated solution is acidified (either by direct addition of acid or by (lactic) fermentation) in the range 2.8<pH<5.2 the protein in the treated solution is stable and does not precipitate or form a curd+serum/whey. In one embodiment, a yoghurt was prepared using the enzyme and spray dried to form a dried powdered ingredient that was subsequently reconstituted as a yoghurt. No acid precipitation step is disclosed to prepare a protein concentrate or to separate off the serum. Indeed, this patent specifically teaches away from such a step. The spray drying procedure would have been inefficient.

WO 9322930 discloses a process where a milk protein (casein) containing solution is treated with a clotting enzyme such as rennet and a few seconds afterwards with the TG enzyme. A microparticulated protein product resulted after a reaction period. There are no steps disclosed of a preheat treatment of the milk, or an acidification of the enzyme treated solution to produce a protein concentrate and separation of the serum. Nor is there disclosed a drying step to produce a powdered ingredient.

It has been shown that some of the major whey proteins (the globular whey proteins) are poorly acted upon in dairy solutions by the enzyme TG (Ikura et al., Use of transglutaminase. Reversible blocking of amino groups in substrate proteins for a high yield of specific products. Agric. Biol. Chem. 1984, 48, 2347-2354). However, reactivity can be markedly improved by partial unfolding of these proteins (Ikura et al., 1984).

In addition, De Jong, Boumans & Wijngaards in W002/35942 reported the discovery of an inhibiting agent in milk and that an ‘intensive preheat treatment of the skimmed milk before the addition of the enzyme TG resulted in a much higher degree of cross linking’. De Jong, Boumans & Wijngaards further found that temperature treatments above about 80° C. resulted in deactivation of the inhibitory agent in the milk. De Jong, Boumans & Wijngaards did not teach how much heat treatment was required beyond the descriptor ‘intensive’.

It would be desirable to produce novel ingredients that yield enhanced performance in the manufacture of a wide range of products that have viscosity or gelation as important functional attributes and that are able to be prepared efficiently.

It is therefore an object of the present invention to go some way toward achieving these desiderata or at lest to offer the public a useful choice.

### SUMMARY OF THE INVENTION

In one aspect the invention is a process for producing a protein composition comprising the steps of:
a) heating a dairy stream to a temperature in the range of 50° C. to 95° C. for a holding time of from about 10 seconds to 30 minutes,
b) adjusting the pH of the stream to between 6.0 and about 8,
c) adding a transglutaminase enzyme to the stream, maintaining the pH at between 6 and 8 and the temperature within the range of 20° C. to 65° C. for a time sufficient to form a protein composition and then deactivating the tranglutaminase enzyme,
d) cooling the stream, where required, and
e) adjusting the reaction conditions in the stream from step d) to cause coagulation of casein in the protein composition by either:
   i) adjusting the pH to less than 5.5 and adding an enzyme capable of converting kappa-casein to para-kappa casein into the stream to form a protein concentrate, or
   ii) adjusting the pH of the stream to about 4.5 to 4.8 to form a protein concentrate, and
f) recovering the protein concentrate so formed.

In one embodiment, wherein the pH of the dairy stream is adjusted to between 8 and 12 prior to step a).

In another embodiment in step e)i) the enzyme is chymosin of animal, vegetable or microbial origin, preferably rennet.

In another embodiment in step e), the stream from step d) is cooled to below about 30° C. before adding the enzyme or lowering the pH, and raised to between 25° C. and 60° C., preferably 350 and 55° C., most preferably between 40° C. and 50° C. thereafter, for from 1 second to 10 minutes, preferably 5 seconds to 200 seconds, more preferably 10 seconds to 100 seconds.

In another embodiment the dairy stream is skim milk.

In another embodiment step e) comprises dividing the stream from step d) into two portions,
adjusting the pH of one portion to less than 5.5 and adding an enzyme capable of converting kappa-casein to para-kappa casein to form a protein concentrate,
adjusting the pH of the other portion to about 4.5 to 4.8 to form a protein concentrate, and recombining the two portions into a single stream containing the protein concentrate.

In another alternative, prior to step a), the pH is adjusted to between 9.0 and 11.0, preferably about 9.5.

In another alternative in step a) a dilute base, preferably sodium hydroxide solution, is added to adjust the pH.

In another alternative in step a), the temperature is between about 60° C. and 90° C., preferably between 70° C. and 85° C.

In another alternative in step a), the holding time is between 20 and 500 seconds, preferably between 50 and 400 seconds.

In another alternative, in step b), the pH is adjusted by the addition of dilute food grade acid, preferably sulphuric acid or hydrochloric acid.

In another alternative in step c), the temperature is adjusted to between about 40° C. and 60° C.

In another alternative, in step c) the transglutaminase enzyme is added at a rate of between about 0.1 and 20 units of enzyme per gram of milk protein present in the stream from step b)

In a further alternative, the transglutaminase is added at a rate of between about 0.5 and 10 preferably between about 0.5 and 5, units of enzyme per gram of milk protein.

In another alternative, step c) is carried out for between about 30 minutes and 24 hours, preferably between 1 and 10 hours.

In another embodiment, in step c) the transglutaminase enzyme is deactivated by heating.

In another embodiment, the pH is adjusted to between about 5.0 and 5.5 before the enzyme is added.

In another embodiment, the enzyme is rennet and the temperature of the stream is between about 5° C. and 60° C. when the rennet is added.

In another embodiment, the rennet is allowed to react for between about 1 minute and 12 hours.

In another embodiment, after the coagulation of the casein, the stream is cooled to below about 20° C.

In another embodiment, in step e), the pH is adjusted by adding a dilute food grade acid, preferably sulphuric acid or hydrochloric acid.

In another embodiment, the process including the additional step of drying the protein composition from step f).

In an alternative embodiment the process includes the step of solublising the protein composition from step f).

In another embodiment, cream, milk fat or edible oil are added to the solublised protein.

The invention is also a milk protein concentrate prepared by the process as defined above.

In another embodiment the invention is a milk protein concentrate in which at least 50% of the whey protein in a dairy stream from which it was produced is bound to the casein from the dairy stream.

In another embodiment the invention is protein concentrate whose 8% (W/W) proteinate aqueous solution at pH 9.5 has a viscosity of at least 1900 cPoise, preferably 2000- 2500 cPoi se.

In another embodiment, a citrate gel of the milk protein concentrate formed in an aqueous solution, having a protein concentration (wet basis) between 16 and 20% and a pH of from 5.6 to 5.7, has a small strain elastic modulus G′ of at least 500 Pa.

Preferably the small strain elastic modulus G′ is between 500 and 6000, Pa.

In another embodiment, a phosphate gel of the milk protein concentrate formed in an aqueous solution, having a protein concentration (wet basis) between 19 and 20% and a pH of from 5.7 to 5.9, has a small strain elastic modulus G′ of at least 450 Pa.

Preferably, the small strain elastic modulus G′ is between 450 and 4000.

In a still further embodiment, the invention is the use of a product of the process defined above as an ingredient in further processing with other ingredients, to prepare food products, preferably cheese and processed cheese products.

The above describes some preferred embodiments of the present invention and indicates several possible modifications but it will be appreciated by those skilled in the art that other modifications can be made without departing from the scope of the invention.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples.

### BRIEF DESCRIPTION OF THE DRAWINGS

FIG. 1 is a flow diagram showing the method according to one embodiment of the invention.

### DETAILED DESCRIPTION OF THE INVENTION

As used herein, “dairy stream” refers to any dairy based liquid which contains milk proteins. Examples are whole milk, skim milk, milk protein concentrates. It can include reconstituted powders.

This invention relates to the preparation of ingredients that are formed by protein-protein interactions derived from enzyme action. Polymers so formed by such interactions are complex. Of particular interest is the reaction involving casein molecules (and casein micelles) with other proteins, particularly but not limited to, soluble proteins and more particularly whey proteins, and the products derived therefrom. Ingredients so formed are found to display novel and useful viscosity and gelation behaviours when used in food systems. The polymer units are prepared by reacting casein and soluble proteins in the presence of an enzyme capable of forming linkages among, and between, such molecules.

### Detailed Description of the Drawing

Skim milk (non-fat milk) may be used from any convenient source, including from reconstituted skim milk powder. If skim milk powder is used, low heat powder is preferred.

Optionally at a convenient stage of the process, the milk may be concentrated using membrane filtration. A preferred embodiment is the use of ultrafiltration to concentrate the milk proteins.

The skim milk stream, after optional pasteurization, is treated with dilute base to a pH of between 9 and 11, preferably about 9.5. A preferred base is sodium hydroxide. The alkaline milk is heated to between 50° C. and 95° C., and more preferably between 60° C. and 90° C. and most preferably between 70° C. and 85° C. The heated milk is held at this temperature for between 10 seconds and 30 minutes, preferably between 20 seconds and 500 seconds and most preferably between 50 seconds and 400 seconds.

Optionally prior to the treatment with the transglutaminase enzyme, the milk may be treated to add or remove calcium. Accordingly, a transglutaminase enzyme may be selected that is either active or inactive in the presence of calcium. Calcium inactive enzymes are preferred.

After the alkaline heat treatment, the milk stream is neutralized with acid to a pH in the range 6.0 to 8.0 and more preferably a pH in the range 6.5 to 8.0. The temperature of the neutralized milk is adjusted preferably to between 20° C. and 80° C., more preferably between 30° C. and 70° C. and most preferably between 50° C. and 60° C.

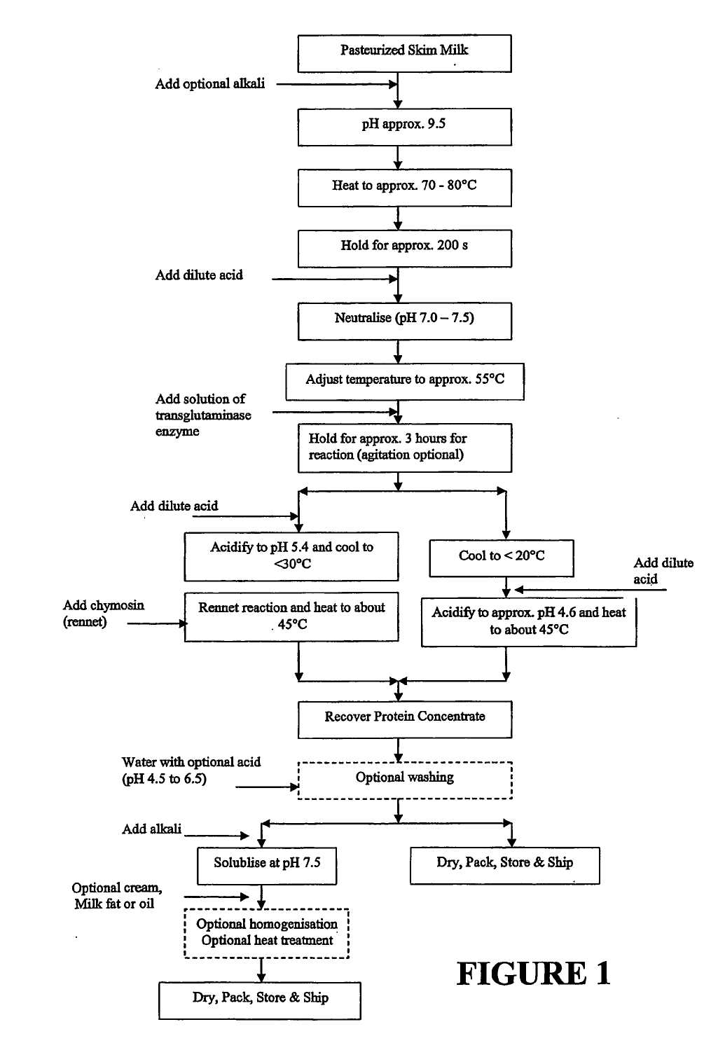

Transglutaminase is added to neutralized milk at the rate of between 0.1 Units (US) and 20 U of enzyme per gram of milk protein, more preferably 0.5 U to 10 U per gram of milk protein and most preferably between 1 U and 10 U per gram of milk protein. The enzyme treated milk is allowed to react for a period of between 30 minutes and 24 hours, more preferably 1 hour and 10 hours. In the embodiment shown in FIG. 1 the holding time was 3 hours. Optionally, during the enzyme reaction period agitation may be applied to the solution.

After the completion of the reaction, the milk may be optionally heat treated to deactivate the enzyme.

Following the completion of the transglutaminase reaction step the stream maybe split into two portions.

Optionally, in one portion, the milk stream is reacted with an enzyme capable of converting kappa-casein to para-kappa casein. In a preferred embodiment, the pH is adjusted to between 5 and 6 and an enzyme capable to forming para-kappa casein is added. A preferred enzyme is rennet and the preferred temperature is between 5° C. and 30° C. for a period of between 1 minute and 12 hours.

The other portion of the stream following the transglutaminase reaction is cooled to <20° C. and the acidified to the isoelectric point of the casein. Any convenient food grade acid may be used but a mineral acid such as sulphuric acid or hydrochloric acid is preferred and the preferred pH is between 4.5 and 4.8 and more preferably between 4.5 and 4.7.

In each separate stream portion, or after the streams have been recombined, the stream is heated to between 25° C. to 60° C., preferably 35° C. to 55° C. and most preferably to between 40° C. to 50° C. It is held at this temperature for a cooking time of between 1 second and 10 minutes, preferably 5 seconds to 200 seconds, most preferably 10 seconds to 100 seconds.

The precipitated protein may be separated from the serum using any convenient means but screens and/or decanters are preferred. Optionally the recovered protein may be washed with water.

In another alternative process the two streams need not be recombined, but instead processed separately. The protein precipitations in either portion could also be used as alternatives to one another in process streams that are not split.

In one alternative, the protein concentrate may be dried using any convenient method.

In another alternative, the protein concentrate may be solublised by the addition of base.

Preferred bases are the hydroxides of sodium, potassium, calcium, magnesium and ammonia Combinations of said bases are contemplated. The preferred pH of the solution is between 6.0 and 8.0. Optionally, a small quantity of acid may be added to adjust the pH back into the preferred range if required.

Optionally cream, milk fat or edible oil may be added to the protein solution. Optionally, the treated milk may be homogenized.

Prior to drying, the protein solution may be given a heat treatment and the pH may be adjusted in the range 6.0 to 8.0 prior to the heat treatment to minimize viscosity.

In one aspect the protein solution may be used as an ingredient without drying. In another aspect the protein solution may be dried and used as a dry ingredient.

The protein solution may be dried using any convenient device, but spray drying is preferred.

Use of Dry Ingredient

The dry ingredient prepared according to this invention maybe used in the production of a range of texturally modified foods and gels. Processed cheese spreads and processed cheese are examples of foods especially advantaged by the incorporation of the ingredients of this invention.

The dry ingredient may also be used in the preparation of a wide range of foods including but not limited to yoghurt, custard, milk shakes, sauces, spreads, dips, cheese products, ice cream, processed cheese, deserts, tofu and tofu products, beverages.

Direct Use

In another aspect the drying procedure may be eliminated and the wet proteinate (either washed or unwashed) may be used directly as an ingredient in the production of a range of texturally modified foods and gels. Processed cheese spreads and processed cheese are examples of foods especially advantaged by the incorporation of the wet proteinate ingredients of this invention.

The invention consists in the foregoing and also envisages constructions of which the following gives examples.

### EXAMPLES

The following non-limiting examples compare the properties of ingredients prepared according to the invention as compared to ingredients prepared by methods known in the art, and further show applications of the ingredients prepared according to the present invention.

### Example 1

### Influence of Enzyme Treatment on Interaction of Casein and Soluble Proteins

Three 800 mL samples of skim milk were given separate treatments:
Sample 1 The first with an alkaline heat treatment but without the use of transglutaminase.
Sample 2 The second without the alkaline heat treatment but with the transglutaminase enzyme (TG Activa, Ajinomoto Co. Inc., Tokyo).
Sample 3 The third with the combined treatments of alkaline heating and enzyme reaction at near neutral pH.

Sample 1 (Skim Milk Treated without the use of Transglutaminase)

Skim milk was treated with 5% NaOH to attain a pH of 9.5. The solution was heated in a water bath for 3 minutes at approximately 75° C. The treated solution was cooled to about 30° C. and then acidified to pH 6.5 using 5% H₂SO₄ and 1 mL of rennet added. The pH was then reduced to 5.4 by the addition of further acid and the temperature increased to 45° C. The protein clotted and was collected by squeezing in a muslin cloth. The serum was collected for analysis.

Sample 2 (Transglutaminase Treated Skim Milk)

Skim milk was pH adjusted to 7.5 with a small quantity of 5% NaOH and then treated with 6 U of transglutaminase per gram of milk protein (Activa TG approx 1100 U/g, Ajinomoto Co. Inc.,) and held in a water bath at 55° C. for 75 minutes for the reaction to proceed. The sample was cooled to about 30° C., acidified to pH 5.4 using 5% H₂SO₄ and rennet (1 mL) was then added and the temperature increased to 45° C. Surprisingly, the protein clotted and was collected by squeezing in a muslin cloth. The serum was collected for analysis.

Sample 3 (Heat/pH Treatment and Transglutaminase)

Skim milk was treated with 5% NaOH to pH 9.5 and heat treated at 75° C. for 3 minutes as for Sample 1. Acid was then added to reduce the pH to 7.5 and then treated with transglutaminase as for Sample 2. After reaction with the transglutaminase for 75 minutes, the sample was cooled to about 30° C., acidified to pH 5.4 using 5% H₂SO₄ and rennet (1 mL) was then added and the temperature increased to 45° C. Surprisingly, the protein clotted and was collected by squeezing in a muslin cloth. The serum was collected for analysis.

The serum samples were analysed for protein using high performance liquid chromatography (HPLC) (Elgar et al., Simultaneous separation and quantitation of the major bovine whey proteins including proteose peptone and caseinomacropeptide by reversed-phase high-performance liquid chromatography on polystyrene-divinylbenzene. J. of Chromatography A. 878, 183-196, 2000). Results of the analysis of the proteins by HPLC are shown in Table 1.

TABLE 1
Results of protein analysis of serum revealed extent of whey protein
removal from serum

| | Proportion of whey protein |
|---|---|
| Treatment | bound to casein (%) |
| Sample 1 | 46 |
| Sample 2 | 25 |
| Sample 3 | 69 |

There is little in the way of an underlying theory to guide the skilled practitioner when applying combinations of pH manipulation, heat and enzymatic treatments to mixtures of casein proteins and soluble (whey) proteins to suggest which proteins will interact in one combination of treatments or another. The results in Table 1 reveal that the proteins that interact by a combination of pH and heat are distinctly different from those that interact by the transglutaminase treatment alone. Surprisingly the combined treatments yield an unexpected additional binding or interaction of the whey proteins to the casein.

### Example 2

### Preparation of Proteinates and Solution Viscosity therefrom

A set of 1000 mL samples of fresh slim milk was subjected to a series of treatments.
Rennet (RENCO “Australian double strength” [280 international clotting units/mL]) was added at the rate of 1:18,000 v/v to a skim milk sample at a temperature of about 9° C. and held in a fridge overnight. The sample was then heated in a water bath to about 45° C. to clot and cook the protein. (Sample designated—“Rennet casein”.)
Skim milk was acidified with 0.5 M sulphuric acid to pH 5.4, heated to about 30° C. in a water bath and then renneted etc. as above. When a clot had formed the sample was then heated in a water bath to about 45° C. to cook the protein. (Sample designated—“Rennet acid casein”.)
Alkali (0.5 M NaOH) was added to a skim milk sample to attain pH 9.5 and then heated to 75° C. for 3 minutes. 0.5 M sulphuric acid was added to pH 4.6 to precipitate the protein. (Sample designated—“Total milk proteinate”.)
Alkali (0.5 M NaOH) was added to attain pH 9.5 and then heated to 75° C. for 3 minutes. The sample was cooled to 30° C. and 0.5 M sulphuric acid was added to pH 5.4 and rennet added to clot the protein. When a clot had formed the sample was cooked at 45° C. to precipitate the protein. (Sample designated—“Renneted total milk proteinate”.)
Alkali (0.5 M NaOH) was added to attain pH 7.5 and then heated to 75° C. for 3 minutes. The sample was cooled to 50° C. and transglutaminase (Ajinomoto, Activa TG) was added at the rate of 6 U/g protein and the mixture held for 75 minutes. The sample was then cooled to 45° C. and acidified with 0.5 M sulphuric acid to pH 4.6 to precipitate the protein. (Sample designated—“TG milk proteinate”.)
Alkali (0.5 M NaOH) was added to attain pH 7.5 and then heated to 75° C. for 3 minutes. The sample was cooled to 50° C. and transglutaminase (Ajinomoto, Activa TG) was added at the rate of 6 U/g protein and the mixture held for 75 minutes. The sample was then cooled to 30° C. and acidified with 0.5 M sulphuric acid to pH 5.4 and rennet added to clot the protein. When a clot had formed the sample was cooked at 45° C. to precipitate the protein. (Sample designated—“TG/rennet proteinate”.)
Alkali (0.5 M NaOH) was added to attain pH 9.5 and then heated to 75° C. for 3 minutes. The sample was adjusted to pH 7.5 using 0.5 sulphuric acid. The sample was cooled to 50° C. and transglutaminase (Ajinomoto, Activa TG) was added at the rate of 6 U/g protein and the mixture held for 75 minutes. The sample was then cooled to 30° C. and acidified with 0.5 M sulphuric acid to pH 5.4 and rennet added to clot the protein. When a clot had formed the sample was cooked at 45° C. to precipitate the protein. (Sample designated—“TG/rennet Total milk proteinate”.)
Alkali (0.5 M NaOH) was added to attain pH 9.5 and then heated to 75° C. for 3 minutes. The sample was adjusted to pH 7.5 using 0.5 sulphuric acid. The sample was cooled to 50° C. and transglutaminase (Ajinomoto, Activa TG) was added at the rate of 6 U/g protein and the mixture held for 75 minutes. The sample was then cooled to 45° C. and acidified with 0.5 M sulphuric acid to pH 4.6 to precipitate the protein. (Sample designated—“TG/Total milk proteinate”.)

The precipitated protein in each sample was collected in a muslin cloth and the surplus serum removed by squeezing. The recovered protein was redissolved in 0.5 M NaOH to give a proteinate solution with a pH of 9.5.

Water was added to standardize the sample concentrations to 8.0% solids, or if the material was not fully soluble or partially gelled, the sample was diluted to 4% solids. The viscosity of each sample was measured at 50° C. using a Brookfield LV viscometer fitted with No. 2 cylinder.

TABLE 2
Viscosity results of samples given various treatments (sequence as
described above)

| | | Rennet | | Renneted | | | TG/rennet | TG/Total |
|---|---|---|---|---|---|---|---|---|
| | Rennet | acid | Total milk | total milk | TG milk | TG/rennet | Total milk | milk |
| Sample | casein | casein | proteinate | proteinate | proteinate | proteinate | proteinate | proteinate |
| Viscosity | 336 | 318 | 12.5 | 13.0 | 457 | 468 | 2550 | Approx. |
| (cPoise) | | | (in the range | (in the range | | | | 2000 |
| | | | 400-500 at | 400-500 at | | | | |
| | | | 8%) | 8%) | | | | |
| Total | 8.0 | 8.0 | 4.0 | 4.0 | 8.0 | 8.0 | 8.0 | 8.0 |
| solids % | | | | | | | | |

The results in Table 2 revealed that the transglutaminase treatment combined with the processing conditions had a dramatic and surprising effect on the viscosity of the protein solutions.

### Example 3

### Preparation of Dried Ingredients and Properties of Gels thus formed

A new set (of 10 L) samples of fresh skim milk was subjected to the treatments given in Example 2:
a. Rennet casein,
b. Rennet acid casein,
c. Total milk proteinate,
d. Renneted total milk proteinate,
e. TG/rennet total milk proteinate,
f. TG/total milk proteinate,
g. TG proteinate.

Fresh skim milk was heated to 75° C. for 3 minutes (without pH adjustment). The sample was cooled to 50° C. and transglutaminase (Ajinomoto, Activa TG) was added at the rate of 6 U/g protein and the mixture held for 75 minutes. The sample was then cooled to 45° C. and acidified with 0.5 M sulphuric acid to pH 4.6 to precipitate the protein. (Sample designated—“TG proteinate”.)

The insoluble proteins recovered from the sera (wheys) were then dried to a powder in a laboratory UniGlatt drier (Glatt Process Technology GmbH, Binzen, Germany) using standard drying conditions to reach an approximate final moisture content of about 3%. For further work, a portion of each powder sample was milled to pass a 600 μm mesh sieve.
h. An additional sample ‘solublised TG/total milk proteinate’ was prepared at semi-commercial scale according to the procedure summarised in Example 5 below.
   Preparation of Gels

Samples of each of the ingredient powders was converted to a standardised set of either citrate or phosphate gels.

Citrate Gels

The aim was to make a gel sample around 50 g weight, with about 16% protein and pH 5.7.

The proportions of tri-sodium citrate dihydrate (TSC) and citric acid (CA) to get the desired pH were ascertained by trial and error. The ingredient weights used are shown in Table 3.

TABLE 3
Quantities used in gel formulations for citrate gels

| | Water | TSC | | Ingredient |
|---|---|---|---|---|
| Proteinate Ingredient | (g) | (g) | CA (g) | (g) |
| a. Rennet casein | 40.2 | 0.68 | 0.41 | 9.8 |
| b. Rennet-acid casein | 40.6 | 0.38 | 0.09 | 9.4 |
| c. Total milk proteinate | 40.1 | 1.9 | 0 | 9.9 |
| d. Renneted total milk proteinate | 40.4 | 0.23 | 0 | 9.6 |
| e. TG/rennet total milk proteinate | 40.3 | 0.25 | 0 | 9.6 |
| f. TG/total milk proteinate | 40.5 | 2.45 | 0 | 9.5 |
| g. TG proteinate | 38.5 | 2.3 | 0 | 9.7 |
| h. Solublised TG/total milk | 41.0 | 0.81 | 0.25 | 9.1 |
| proteinate | | | | |

The method as follows was conducted at room temperature.
1. The water was weighed into a 100 ml plastic pottle.
2. The TSC and CA were weighed out, added to the water and stirred with a spatula to dissolve.
3. The proteinate ingredient was then weighed out and added to the dissolved salts with stirring to disperse.
4. The mixture was stirred using a spatula for a few minutes, then periodically over the next 30-40 minutes.
5. The plastic pottle containing the resultant gel/mixture, was closed (top screwed on) and placed into a fridge to allow the gel structure to fully develop and stabilise until rheology measurements were made (over the next 24-48 hr).

6. The gels were removed from the fridge and allowed to reach ambient temperature (about 20° C.) before the texture was analysed.

Phosphate Gels

The aim was to make a gel sample around 50 g weight, with about 17% protein and pH 5.7.

A set amount of sodium hexametaphosphate (SHMP) was added, with various amounts of 5 M hydrochloric acid (HCl) and 5 M sodium hydroxide (NaOH) added to get the desired pH (the proportions required were ascertained by trial and error). The ingredient weights used are shown in Table 4.

TABLE 4
Quantities used in gel formulations for phosphate gels

| | | | | | | Ingre- |
|---|---|---|---|---|---|---|
| | | Water | SHMP | HCl | NaOH | dient |
| Proteinate Ingredient | | (g) | (g) | (mL) | (mL) | (g) |
| a. | Rennet casein | 38.0 | 1.125 | 0.75 | 0 | 9.8 |
| b. | Rennet-acid casein | 38.9 | 1.125 | 0.13 | 0 | 9.4 |
| c. | Total milk proteinate | 38.6 | 1.125 | 0 | 0.7 | 9.9 |
| d. | Renneted total milk | 39.0 | 1.125 | 0.01 | 0 | 9.6 |
| | proteinate | | | | | |
| e. | TG/rennet total milk | 38.6 | 1.125 | 0 | 0.05 | 9.6 |
| | proteinate | | | | | |
| f. | TG/total milk | 38.4 | 1.125 | 0 | 0.75 | 9.5 |
| | proteinate | | | | | |
| g. | TG proteinate | 39.7 | 1.125 | 0 | 0.63 | 9.7 |
| h. | Solublised TG/total | 40.1 | 1.125 | 0.25 | 0.25 | 9.1 |
| | milk proteinate | | | | | |

The method as follows was carried out at room temperature.
1. The water was weighed into a 100 ml plastic pottle.
2. The SHMP was weighed out, added to the water and stirred with a spatula to dissolve.
3. The HCl or NaOH was added to the water and mixed in.
4. The proteinate ingredient was then weighed out and added to the dissolved salts with stirring to disperse.
5. The mixture was stirred using a spatula for a few minutes, then periodically over the next 20-30 minutes.
6. The plastic pottle containing the resultant gel/mixture, was closed (top screwed on).
7. Rheology measurements were made between 1 and 2 hours after the gel was made.

Texture was assessed by measuring the small strain oscillatory elastic modulus (G′) of a sample of the resulting product. The small strain oscillatory elastic modulus was obtained at 0.1 Hz and a strain of 0.005 using a texture analyser TA AR2000 rheometer (TA Instruments—Waters LLC, New Castle, USA) at 20° C. using the method described by Lee S. K. & Klostermeyer H., Lebensm.-Wiss. U-Technol., 34,288-292 (2001). (A description of elastic modulus is detailed in Ferry (Ferry, J. D., (Ed.), Viscoelastic Properties of Polymers, 3^{rd} edn. New York. John Wiley & Sons. 1980)).

The results are shown in Table 5

TABLE 5
Properties of gels prepared from proteinate ingredients

| | | | | | | | | Solublised |
|---|---|---|---|---|---|---|---|---|
| | | | | Renneted | TG/rennet | TG/total | | TG/total |
| | Rennet | Rennet | Total milk | total milk | total milk | milk | TG | milk |
| | casein | acid casein | proteinate | proteinate | proteinate | proteinate | proteinate | proteinate |
| | Citrate Gels | | | | | | | |
| pH | 5.6 | 5.6 | 5.6 | 5.8 | 5.7 | 5.6 | 5.6 | 5.7 |
| Protein % | 15.9 | 15.9 | 18.4 | 17.2 | 15.7 | 17.9 | 19.8 | 18.2 |
| G′ (Pa) | 3.5 | 3.0 | 34 | 38 | 1849 | 1723 | 5510 | 519 |
| | Phosphate Gels | | | | | | | |
| pH | 5.7 | 5.7 | 5.8 | 5.8 | 5.7 | 5.7 | 5.9 | 5.8 |
| Protein % | 19.2 | 19.0 | 19.8 | 19.1 | 19.2 | 19.6 | 19.2 | 19.9 |
| G′ (Pa) | 182 | 8.7 | 244 | 45 | 3610 | 3320 | 3725 | 460 |

The results in Table 5 revealed that novel TG treated ingredients could be solublised and converted into gels that have prospective application in food systems. Compared with conventionally treated controls (i.e. non-TG treated samples), the results also showed that TG treated ingredients had a dramatic and potentially useful effect on small strain gel strengths in the pH region of importance to many food products of which cheese, processed cheese and processed cheese spreads are important examples.

### Example 4

### Preparation and Properties of Model Processed Cheese Spreads

Using a model cheese spread recipe, the ingredients of the above series (a-g) were used to establish whether a satisfactory emulsion and gel could be formed when fat or oil was present and what textures (measured as G′) resulted.

Basic Recipe

The recipe used to prepare the spread samples is shown in Table 6.

TABLE 6
Quantities of ingredients used for preparing spread samples

| Ingredient | Mass (g) | Percentage (%) |
|---|---|---|
| Water | 14.88 | 49.6 |
| Soya oil | 9.41 | 31.4 |
| Ingredient e.g. Rennet casein | 3.01 | 10.0 |
| Lactose.H₂O | 0.84 | 2.8 |
| Whey protein concentrate | 0.72 | 2.4 |
| Tri-sodium citrate.2H₂O | 0.67 | 2.2 |
| Salt | 0.30 | 1.0 |
| Citric acid | 0.17 | 0.6 |
| TOTAL | 30.00 | 100 |

Target Composition

The spreads had a nominal composition which is shown in Table 7.

TABLE 7
Nominal composition of spread samples

| Component | Percentage (%) |
|---|---|
| Water | 51 |
| Fat | 32 |
| Protein | 10 |
| Lactose | 3 |
| Salt | 1 |
| Other | 3 |
| (pH) | 5.70 |

TCA, CA and salt were dissolved in the water in a plastic beaker. The selected proteinate ingredient, e.g. rennet casein, was added and mixed in. Once dispersed, the container was allowed to sit at room temperature for 2 hours with occasional stirring of the hydrating mixture. Soya oil, whey protein concentrate (ALACEN 392™, Fonterra Co-operative Group Limited, Auckland, New Zealand) and lactose powder were added to the hydrated material and the blend vigorously mixed by hand for 30 seconds. The blend was then carefully transferred to a RVA canister (Rapid Visco™ Analyser [RVA-4], Newport Scientific, Warriewood, Australia) for cooking using the following agitation profile:
30 seconds at 200 rpm,
2 minutes 30 seconds at 300 rpm,
3 minutes at 600 rpm,
1 minute at 1000 rpm,
7 minutes at 2000 rpm.

For the first 5 minutes the temperature was held at 25° C. Over the next 3 minutes, the temperature was raised to 85° C. and held until the end of the cook (total time of 13.5 minutes).

The hot spread sample was transferred to a plastic pottle, a lid fitted and then cooled under running water for 15 minutes. The container was then transferred to a refrigerator (5° C.). The texture (G′) was measured in triplicate at age 7 days using a texture analyser TA AR2000 (TA Instruments—Waters LLC, New Castle, USA). The conditions of the small strain oscillatory elastic modulus (G′) measurement were 20° C., 0.1 Hz and strain of 0.005.

Textures of Spreads

The textures of the spreads measured as G′ are shown in Table 8.

TABLE 8
Summary of properties of spread samples

| | | | | | | | Solublised |
|---|---|---|---|---|---|---|---|
| | | | | Renneted | TG/rennet | TG/total | TG/total |
| | Rennet | Rennet acid | Total milk | total milk | total milk | milk | milk |
| | casein | casein | proteinate | proteinate | proteinate | proteinate | proteinate |
| pH | All values 5.68 ± 0.05 | | | | | | |
| Moisture % | All values 50.8 ± 0.5 | | | | | | |
| Protein % | NA | 9.9 | 10.2 | NA | 10.2 | 10.1 | 9.7 |
| G′ (Pa) | 411 | 80 | 709 | 213 | 3340 | 3230 | 1450 |

(The G′ values in Table 8 were the average of at least two separate batches prepared from each ingredient and three texture measurement replicates of each batch.)

The results in Table 8 showed that the TG ingredients were able to form satisfactory model spreads and that the TG treatment dramatically enhanced the texture of the spreads.

### Example 5

### Preparation of Processed Cheese Slice

A trial sample of solublised TG treated total milk proteinate was prepared at semi-commercial scale.

Skim milk was taken and adjusted to pH 9.6 using diluted sodium hydroxide. This milk was then heated to 78° C. and held at this temperature for approximately 200 seconds.

The milk was then cooled to less than 20° C. and acidified back to pH 7.0 using diluted sulphuric acid. The milk was then heated to 50° C. and TG enzyme (Ajinomoto concentrate) was added at a ratio of 1:2500 (enzyme:protein). The milk was then held for approximately 2.5 hours at 50° C. then cooled to approximately 20° C. and acidified to pH 4.6 using diluted sulphuric acid.

The milk was then heated to approximately 55° C. and the resulting precipitated protein was separated from the whey serum. The precipitated protein (curd) was washed free of lactose and minerals then diluted with water to approximately 15-20% total solids. The protein suspension was then solubilized using dilute sodium hydroxide to pH 6.8. This solublised milk protein was then spray dried to a soluble powder ingredient with a protein content of approximately 90% and a moisture content of about 4%.

A sample was then used to prepare the processed cheese as described below.

Processed Cheese Preparation

A batch of processed cheese slices was prepared using the formulation shown in Table 9.

TABLE 9
Formulation of processed cheese

| Ingredient | Quantity (kg) |
|---|---|
| Proteinate ingredient according to present | 2.01 |
| invention from Example 5 | |
| Cheddar (matured) | 2.40 |
| Butter (salted) | 2.448 |
| Whey protein concentrate (80% protein) | 0.090 |
| Sweet whey powder | 1.568 |
| Tri-sodium citrate.2H₂O | 0.446 |
| Lactic acid (88%) | 0.090 |
| Salt | 0.22 |
| Added Water | 4.405, 0.60, 0.30 |
| Condensate (allowance) | 1.67 |
| Colourant | 0.012 |
| Sorbic acid | 0.032 |

(1) The butter was added to a 40 lb twin screw Blentech process cheese cooker. The fat was worked until semi-fluid.
(2) The proteinate ingredient made according to the present invention was added, followed by the salt, and mixed until a smooth paste was achieved, typically in about 1-2 minutes.
(3) The ground Cheddar cheese, emulsifying salts, whey powder, whey concentrate powder and colourant were added, and the mass was mixed until uniform, typically about 5 minutes from the beginning of the process at step 1.
(4) The water and acids were then added and the mass further mixed until uniform.
(5) The mass was then heated with direct steam and/or indirect heat and agitated to a temperature of about 85° C., over a 3 to 7 minute period.
(6) The molten mass was then poured onto a cold table and once set, was cut into square slices.

The slices made using an ingredient according to the present invention had the characteristics of good quality processed cheese.

### Example 6

### Application of Transglutaminase-treated Proteinate in IWS Processed Cheese, Effect on Texture and Comparison with Control

Background

The purpose of this experiment was to establish that the extra firmness observed in processed cheese spread systems containing transglutaminase-treated protein ingredients, would apply to a processed cheese slice system (eg individually wrapped slice [IWS]). The first formulation (Control) was based on a traditional IWS recipe using a blend of cheeses selected to provide the desired combination of texture and flavour. The particular combination of ingredients in the Control were chosen to make a soft sticky slice. The second formulation (Formulation 2) had an identical target composition (% protein, % fat, % salts, % moisture & pH) to the Control but some of the young cheese i.e. the cheese component responsible for giving body (texture) was replaced with the appropriate quantities of transglutaminase-treated renneted TIP and the non-cheese ingredients were rebalanced accordingly.

Recipe

The formulations used are shown in Table 10. The overall target composition is shown in Table 11.

TABLE 10
Ingredients used in Control & Formulation 2

| | Control | | Formulation 2 | |
|---|---|---|---|---|
| Ingredient | Mass (g) | (%) | Mass (g) | (%) |
| Cheddar 900* | 5.30 | 17.7 | 2.30 | 7.7 |
| Cheddar 600* | 14.20 | 47.3 | 14.20 | 47.3 |
| Cheddar* (matured for >12 | 1.20 | 4.0 | 1.20 | 4.0 |
| months) | | | | |
| Butter (salted) | — | — | 1.38 | 4.6 |
| TG TMP Renneted | — | — | 1.10 | 3.7 |
| [Proteinate (e.) of Example | | | | |
| 3] | | | | |
| Water | 7.50 | 25.0 | 8.14 | 27.1 |
| Tri-sodium citrate.2H₂O | 0.87 | 2.9 | 0.87 | 2.9 |
| Lactose | 0.40 | 1.3 | 0.40 | 1.3 |
| Alacen 392 ™ | 0.30 | 1.0 | 0.14 | 0.5 |
| Salt | 0.19 | 0.6 | 0.23 | 0.8 |
| Citric acid | 0.04 | 0.1 | 0.04 | 0.1 |
| TOTAL | 30.00 | 100 | 30.00 | 100 |

*supplied by Fonterra Co-operative Limited, Auckland, New Zealand.

Target Composition

The target composition is based on the prepared formulation at the commencement of the cooking procedure. The final IWS compositions will contain slightly less moisture and a concomitant increase in the other components.

TABLE 11
Composition for IWS slices

| | | Measured by analysis on |
|---|---|---|
| Component | Calculated (%) | product (%) |
| Water | 47.5 | |
| Fat | 25.7 | |
| Protein | 18.4 (based on true protein) | 19.2 ± 0.1 (as crude protein) |
| Salt | 1.8 | |
| Lactose | 1.4 | |
| pH | | 5.60 ± 0.05 |

Procedure

The IWS samples were prepared as follows.

Control

The cheese was finely shredded and placed in a plastic beaker along with the remaining ingredients (all at room temperature). The blend was vigorously mixed by hand for 30 seconds.

The blend was then carefully transferred to an RVA canister for cooking using the following mixing profile in the RVA (Rapid Visco Analyser [RVA-4], Newport Scientific, Warriewood, Australia):
1. 30 seconds at 0 rpm
2. 30 seconds at 20 rpm
3. 1 minute at 100 rpm
4. 1 minute at 200 rpm
5. 7 minutes at 600 rpm

Over 4 minutes the temperature was raised from 25° C. to the cooking temperature of 85° C. and then held steady until the end of the cooking period (total time of 10 minutes).

Towards the end of the cooking period, an indicative viscosity of the melt was given by the torque reading from the RVA. This ranged between 1400 & 1500 (arbitrary units). The molten mass was smooth and homogenous.

The hot product was poured onto polypropylene film and a second layer of film placed on top. The product was then rolled flat to form an IWS slice with a thickness of 2 mm.

The procedure was repeated.

The IWS slices were then placed in a plastic bag and transferred onto a pre-cooled aluminium plate in a refrigerator (5° C.). The firmness (texture G′) of the slice was measured after allowing the texture to stabilise for 5 days.

Formulation 2

Tri-sodium citrate and salt were dissolved in the water in a plastic container. The TG TMP was added and mixed in. Once dispersed, the container was allowed to sit at room temperature for 2 hours with occasional sting of the hydrating mixture. Shredded cheeses, butter, Alacen 392™, lactose and citric acid were place in a plastic beaker and the hydrated TG TMP mixture added. The blend was vigorously mixed by hand for 30 seconds and then carefully transferred to an RVA canister and cooked using the shear and temperature profile on the RVA used for the Control.

Towards the end of the cooking period, an indicative viscosity of the melt was given by the torque reading from the RVA. This ranged between 2800 & 3100 (arbitrary units). The molten mass was smooth, homogenous and noticeably more viscous than the Control.

The hot product was formed into a slice as for the Control and its firmness measured at age 5 days. The procedure was repeated.

Texture Results

Control Run 1 G′17,900 Pa (average of3 measurements)

Run 2 G′19,600 Pa (average of 4 measurements)
   Formulation 2 Run 1 G′31,700 Pa (average of 5 measurements)
Run 2 G′29,500 Pa (average of 4 measurements)

The texture of the Control was characteristic of a soft IWS slice as expected from the formulation selected. In contrast, the sample incorporating the TG treated proteinate of this invention (at the level of about 4% of the formulation) resulted in a very acceptable slice with a surprising 50 to 80% increase in G′.

1. A process for producing a protein composition comprising the steps of:
a) heating a dairy stream to a temperature in the range of 50° C. to 95° C. for a holding time of from about 10 seconds to 30 minutes,
b) adjusting the pH of the stream to between 6.0 and about 8,
c) adding a transglutaminase enzyme to the stream, maintaining the pH at between 6 and 8 and the temperature within the range of 20° C. to 65° C. for a time sufficient to form a protein composition and then deactivating the transglutaminase enzyme,
d) adjusting the reaction conditions in the stream to cause coagulation of casein in the protein composition by either:
i) adjusting the pH to less than 5.5 and adding an enzyme capable of converting kappa-casein to para-kappa casein into the stream to form a protein concentrate, or
ii) adjusting the pH of the stream to about 4.5 to 4.8 to form a protein concentrate, and
e) recovering the protein concentrate so formed.

2. The process of claim 1, wherein the pH of the dairy stream is adjusted to between 8 and 12 prior to step a).

3. The process of claim 1, wherein in step d)i) the enzyme is chymosin of animal, vegetable or microbial origin.

4. The process of claim 1, wherein in step d), the stream) is cooled to below about 30° C. before adding the enzyme in step d)i) or lowering the pH in step d)ii).

5. The process of claim 1, wherein the dairy stream is skim milk.

6. The process of claim 1, wherein the step d) comprises dividing the stream into two portions,
adjusting the pH of one portion to less than 5.5 and adding an enzyme capable of converting kappa-casein to para-kappa casein to form a first protein concentrate,
adjusting the pH of the other portion to about 4.5 to 4.8 to form a second protein concentrate, and
recombining the two portions into a single stream containing the first and second protein concentrates.

7. The process of claim 2 wherein prior to step a) the pH is adjusted to between 9.0 and 11.0.

8. The process of claim 7 wherein a dilute base is added to adjust the pH.

9. The process of claim 1, wherein in step a) the temperature is between about 60° C. and 90° C.

10. The process of claim 1 wherein in step a) the holding time is between 20 and 500 seconds.

11. The process of claim 1, where in step b) the pH is adjusted by the addition of dilute food grade acid.

12. The process of claim 1, wherein in step c) the temperature is adjusted to between about 40° C. and 60° C.

13. The process of claim 1, wherein in step c) the transglutaminase enzyme is added at a rate of between about 0.1 and 20 units of enzyme per gram of milk protein present in the stream from step b).

14. The process of claim 13, wherein the transglutaminase is added at a rate of between about 0.5 and 10 units of enzyme per gram of milk protein.

15. The process of claim 1 wherein step c) is carried out for between about 30 minutes and 24 hours.

16. The process of claim 1, wherein in step c) the transglutaminase enzyme is deactivated by heating.

17. The process of claim 1, wherein the pH is adjusted to between about 5.0 and 5.5 before the enzyme is added in step d)i).

18. The process of claim 17, wherein the enzyme is rennet and the temperature of the stream is between about 5° C. and 60° C. when the rennet is added.

19. The process of claim 18, wherein the rennet is allowed to react for between about 1 minute and 12 hours.

20. The process of claim 1, wherein after step d), the stream is cooled to below about 20° C.

21. The process of claim 1 wherein, in step d), the pH is adjusted by adding a dilute food grade acid.

22. The process of claim 1, including the additional step of drying the protein composition from step e).

23. The process of claim 1, which includes the step of solublising the protein composition from step f).

24. The process of claim 23, wherein cream, milk fat or edible oil are added to the solublised protein.

25. A product prepared by the process of claim 1.

26. A milk protein concentrate in which at least 50% of the whey protein in a dairy stream from which it was produced is bound to the casein from the dairy stream.

27. The milk protein concentrate of claim 26, wherein an 8% (W/W) proteinate aqueous solution at pH 9.5 has a viscosity of at least 1000 cPoise.

28. The milk protein concentrate of claim 26 whose citrate gel when formed in an aqueous solution, and having a protein concentration (wet basis) between 16 and 20% and a pH of from 5.6 to 5.7, has a small strain elastic modulus G′ of at least 500 Pa.

29. The milk protein concentrate of claim 28, wherein the small strain elastic modulus G′ is between 500 and 6000 Pa.

30. The milk protein concentrate of claim 26 whose phosphate gel when formed in an aqueous solution, and having a protein concentration between 19 and 20% (wet basis) and a pH of from 5.7 to 5.9, has a small strain elastic modulus G′ of at least 450 Pa.

31. The milk protein concentrate of claim 30, wherein the small strain elastic modulus G′ is between 450 and 4000 Pa.

32. Use of a milk protein concentrate of claim 26 as an ingredient in further processing with other ingredients, to prepare food products.

33. The process of claim 1, additionally comprising cooling the stream between steps c) and d).

34. The process of claim 3, wherein the enzyme is rennet.

35. The process of claim 4, wherein the temperature is subsequently adjusted to between 25° C. and 60° C. for from 1 second to 10 minutes.

36. The process of claim 35 wherein the temperature is adjusted to between 35° and 55° C.

37. The process of claim 35, wherein the temperature is adjusted to between 40° C. and 50° C.

38. The process of claim 35 wherein the temperature is adjusted for from 5 seconds to 200 seconds.

39. The process of claim 35 wherein the temperature is adjusted for from 10 seconds to 100 seconds.

40. The process of claim 7, wherein the pH is adjusted to about 9.5.

41. The process of claim 8, wherein the dilute base is sodium hydroxide.

42. The process of claim 9, wherein the temperature is between 70° C. and 85° C.

43. The process of claim 10, wherein the holding time is between 50 and 400 seconds.

44. The process of claim 11, wherein the dilute food grade acid is selected from the group consisting of sulphuric acid and hydrochloric acid.

45. The process of claim 14, wherein the transglutaminase is added at a rate of between about 0.5 and 5 units of enzyme per gram of milk protein.

46. The process of claim 15, wherein step c) is carried out for between about 1 hour and 10 hours.

47. The process of claim 21, wherein the dilute food grade acid is selected from the group consisting of sulphuric acid and hydrochloric acid.

48. Use of the product of claim 25, as an ingredient in the preparation of food products.

49. The concentrate of claim 27, wherein the viscosity is between about 2000 and 2500 cPoise.

50. The use of claim 32, wherein the food products are cheese or processed cheese products.
